(19) United States
(12) Patent Application Publication
(10) Pub. No.: US 2007/0003718 A1
(43) Pub. Date: Jan. 4, 2007

(54) Reflector, heating crucible equipped with reflector and process for preparation of radiation image storage panel

(75) Inventors: Tomoaki Nakashima, Ashigara-kami-gun (JP); Yukihisa Noguchi, Odawara-shi (JP); Munetaka Kato, Ashigara-kami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/476,802

(22) Filed: Jun. 29, 2006

(30) Foreign Application Priority Data
Jun. 29, 2005 (JP) 2005-189506
May 23, 2006 (JP) 2006-142856

(51) Int. Cl. B05D 3/00; B28B 11/00; C03C 17/32

(52) U.S. Cl. 428/34.4; 427/561; 428/34.6

(57) ABSTRACT

A heating crucible which generates heat when electricity is supplied and an insulating reflector having a shape surrounding and covering the crucible is combined.

### FIELD OF THE INVENTION

The present invention relates to a reflector covering a heating crucible used for melting and/or vaporizing solid materials, a combination of a heating crucible and the reflector, and a process for preparing a radiation image storage panel utilizing the combination of the heating crucible and reflector.

### BACKGROUND OF THE INVENTION

For improving thermal efficiency of a high-temperature heating apparatus, a reflector such as a metal plate is generally installed therein so as to insulate and retain heat in the apparatus. For example, JP-A-6-124955 discloses a high-temperature vacuum furnace in which plural reflectors are placed around (namely, above, under and beside) a heater. Those reflectors are made of a metal of a high melting point, such as tantalum (Ta) and molybdenum (Mo). JP-A-2000-150396 further discloses a reflector in the shape of a sheet. The sheet reflector disclosed in the publication comprises metal foil sandwiched between quartz plates. It is known that reflectors are made of ceramics.

Crucibles are usually used for melting and/or vaporizinig solid materials. For example, a heating crucible, which generates heat to serve as a heater by itself when electricity is supplied, is often used in a vapor-deposition process utilizing resistance-heating. In the process, an evaporation source is placed within the heating crucible and then electricity is directly supplied to the crucible, whereby the evaporation source would be heated and vaporized.

It has been proposed to utilize the vapor-deposition process for producing a radiation image storage panel (often referred to as “energy-storing phosphor sheet”), which is a sheet comprising a substrate and an energy-storing phosphor and which is used in a radiation image recording and reproducing method. In the vapor-deposition process, the energy-storing phosphor is vaporized and accumulated on the substrate.

When exposed to radiation such as X-rays, the energy-storing phosphor (e.g., stimulable phosphor, which gives off stimulated emission) absorbs and stores a portion of the radiation energy. The phosphor then emits stimulated emission according to the level of the stored energy when exposed to an electromagnetic wave such as a visible or infrared light (i.e., stimulating light). The energy-storing phosphor is utilized in a radiation image recording and reproducing method, which has been widely employed in practice. The method comprises the steps of: exposing a radiation image storage panel to radiation having passed through an object or having radiated from an object, so that radiation image information of the object is temporarily recorded in the panel; sequentially scanning the panel with a stimulating light such as a laser beam to emit stimulated light; and photoelectrically detecting the emitted light to obtain electric image signals. The storage panel thus treated is subjected to a step for erasing radiation energy remaining therein, and then stored for the use in the next radiation image recording and reproducing procedure. Thus, the radiation image storage panel can be repeatedly used.

The radiation image storage panel has a basic structure comprising a substrate and an energy-storing phosphor layer provided thereon. However, if the phosphor layer is self-supporting, the support may be omitted. Further, a protective layer is generally provided on or over the free surface (surface not facing the support) of the phosphor layer so as to keep the phosphor layer from chemical deterioration or physical damage.

The phosphor layer formed by the vapor-deposition process contains no binder and consists of only the phosphor in the form of columnar crystals, and there are gaps among the columnar crystals. Because of the gaps, the stimulating light can stimulate the phosphor efficiently and the emitted light can be collected efficiently, too. Accordingly, a storage panel having the phosphor layer of columnar crystals has high sensitivity. At the same time, since the gaps prevent the stimulating light from diffusing parallel to the phosphor layer, the storage panel can give a reproduced image of high sharpness.

During the vapor-deposition process for forming the phosphor layer, heat in the heating crucible is often unevenly distributed. If the crucible charged with the evaporation source has too much thermal unevenness, not only the evaporation source is vaporized to give out streams of the vapor but also the evaporation source undergoes bumping at highly heated positions. The bumping disturbs formation of the columnar crystals, and the deposited phosphor layer often consists of anomalous columnar crystals and has unfavorable surfaces. Consequently, the resultant radiation image storage panel gives a radiation image having many point defects.

Further, in the process, the heat radiated from the crucible is liable to elevate the temperature of the substrate (on which the vaporized substance is deposited and accumulated) beyond the predetermined temperature. Also in that case, anomalous columnar crystals are formed and the resultant storage panel has poor emission properties (for example, in regard to emission intensity). Furthermore, if two or more heating crucibles are used for performing multi-vapor deposition or for forming an evenly deposited layer, vaporization from one crucible is often influenced by the heat radiated from the other crucibles.

### SUMMARY OF THE INVENTION

It is an object of the present invention to provide a reflector capable of covering a heating crucible so that heat in the crucible would be efficiently insulated and evenly distributed.

It is another object of the invention to provide a combination of a heating crucible and a reflector in which the heating crucible can retain even thermal distribution therein.

It is still another object of the invention to provide a process for preparing a radiation image storage panel in which bumping of the evaporation source in the vapor-deposition process is prevented effectively enough so as to produce a radiation image storage panel having high sensitivity and giving a reproduced radiation image of high quality.

The applicant has studied the above-described problems, and finally found that the thermal evenness in the heating crucible can be ensured by the use of an insulating reflector having a shape covering the crucible. The reflector can be combined with the heating crucible and then removed from the heating crucible (which generates heat to work as a heater by itself when electricity is supplied) so as to cancel the uneven thermal distribution in the crucible and, at the same time, to keep the crucible from radiating heat so that the radiated heat would not influence other adjacent crucibles and the substrate onto which the phosphor layer is formed.

The present invention resides in an insulating reflector having a shape surrounding and covering a heating. crucible which generates heat when electricity is supplied.

The invention also resides in a combination of a heating crucible which generates heat when electricity is supplied and an insulating reflector having a shape surrounding and covering the crucible.

The invention further resides in a process for preparing a radiation image storage panel having a substrate and a phosphor layer, which comprises the step of placing an evaporation source of the phosphor in the crucible of the combination of claim 3, and heating the crucible under vacuum to vaporize the evaporation source and depositing the vaporized source on the substrate whereby forming the phosphor layer.

The reflector of the invention has a shape surrounding and covering a heating crucible, and hence can prevent the crucible from radiating heat outside so as to insulate and retain the heat therein. The uneven thermal distribution in the crucible is, therefore, remarkably reduced or minimized to prevent bumping in the vapor-deposition process. In addition, since the crucible is thus kept from radiating heat, the substrate is not so heated and thermal interference among plural crucibles is avoided. Accordingly, it is easy to control the amount of vapor evaporated from each crucible properly enough to form a uniformly deposited layer. Further, since the crucible can be kept from scorching, it can be used for long period of time. Naturally, thermal efficiency of the evaporation-deposition apparatus is improved.

If the crucible equipped with the reflector of the invention is used in the vapor-deposition process for forming a phosphor layer in producing a radiation image storage panel, the produced storage panel has high sensitivity and gives a reproduced radiation image of high quality.

### BRIEF DESCRIPTION OF DRAWINGS

FIG. 1 is a sketch schematically illustrating an example of the heating crucible.

FIG. 2 is a sketch schematically illustrating an example of the insulating reflector according to the invention. The reflector shown in FIG. 2 can be placed on the heating crucible of FIG. 1.

FIG. 3 is a sketch schematically illustrating the heating crucible of FIG. 1 covered with the reflector of FIG. 2.

FIG. 4 is a sketch schematically illustrating the heating crucible of FIG. 1 covered with another example of the reflector according to the invention.

FIG. 5 is a sketch schematically illustrating the heating crucible of FIG. 1 covered with a still another example of the reflector according to the invention.

FIG. 6 is a sectional view schematically illustrating an exanple of the evaporation-deposition apparatus used in the invention.

### DETAILED DESCRIPTION OF THE INVENTION

The following are preferred embodiments of the reflector and the combination according to the invention.

(1) The insulating reflector is made of ceramics.

(2) The reflector comprises a cylindrical side-covering unit having a longitudinal aperture along a center axis of the covering unit and a pair of end-covering disc plates.

(3) In the combination, the heating crucible is in the form of a cylindrical container having a curved side surface on which a longitudinal aperture is formed along a center axis of the container and end surfaces to which an electric terminal is fixed, and at least 70% of an outer surface of the crucible is enclosed with the reflector.

(4) In the combination of (3) above, at least 90% of the outer surface of the crucible is enclosed with the reflector.

(5) In the combination of (3) above, the heating crucible is made of a metal selected from the group consisting of tantalum, molybdenum, tungsten and niobium.

(6) The gap between the reflector and the crucible is in the range of 0.5 to 30 mm.

(7) The thickness of the reflector is in the range of 0.1 to 30 mm.

The following are preferred embodiments of the process of the invention for the preparation of a radiation image storage panel.

(1) Two or more heating crucibles are used in the vapor-deposition process for forming the phosphor layer.

(2) The vacuum degree in the vapor-deposition process is in the range of 0.1 to 10 Pa.

(3) The phosphor is an alkali metal halide stimulable phosphor represented by the following formula (I):
M^{I}X·aM^{II}X′₂·bM^{III}X″₃:zA (I)
in which M^{I} is at least one alkali metal selected from the group consisting of Li, Na, K, Rb and Cs; M^{II} is at least one alkaline earth metal or divalent metal selected from the group consisting of Be, Mg, Ca, Sr, Ba, Ni, Cu, Zn and Cd; M^{III} is at least one rare earth element or trivalent metal selected from the group consisting of Sc, Y, La, Ce, Pr, Nd, Pm, Sm, Eu, Gd, Th, Dy, Ho, Er, Tm, Yb, Lu, Al, Ga and In; A is at least one rare earth element or metal selected from the group consisting of Y, Ce, Pr, Nd, Sm, Eu, Gd, Tb, Dy, Ho, Er, Tm, Yb, Lu, Mg, Cu and Bi; each of X, X′ and X″ is independently at least one halogen selected from the group consisting of F, Cl, Br and I; and a, b and z are numbers satisfying the conditions of 0≦a<0.5, 0≦b<0.5 and 0≦z<1.0, respectively.

(4) In the above formula (I), M^{I}, A and z are Cs, Eu and a number satisfying the condition of 1×10⁻⁴≦z≦0.1, respectively.

In the following description, the reflector and the combination of the heating crucible and reflector according to the invention are explained in detail with reference to the attached drawings.

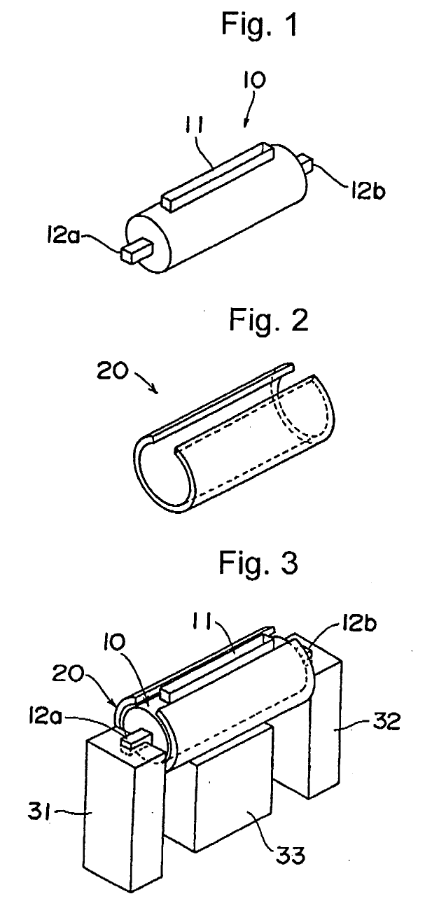

FIG. 1 is a sketch schematically illustrating an example of the heating crucible, and FIG. 2 is a sketch schematically illustrating an example of the reflector according to the invention. FIG. 3 is a sketch schematically illustrating the heating crucible of FIG. 1 covered with the reflector of FIG. 2.

In FIG. 1, the heating crucible 10 is a cylindrical container. On the curved side surface of the cylindrical container, an aperture 11 is opened longitudinally along the axis of the cylinder. Further, at the center of each flat end surface of the cylindrical crucible, an electric terminal 12a, 12b is provided. The heating crucible 10, generates heat when electricity is supplied from the electric terminals 12a, 12b, to serve as a heater by itself. This type of crucible is referred to as “direct resistance-heating crucible”, and is generally made of a high-melting point metal such as tantalum (Ta), molybdenum (Mo), tungsten (W) and niobium (Nb). Through the longitudinal aperture 11, materials to be heated, melted and vaporized are introduced into the crucible 10. The electric terminals 12a, 12b are then connected to electrodes, and an electric current is made to flow into the crucible 10. The whole crucible 10 is thus made to heat, and the melted and vaporized substance is given out from the aperture 11.

As shown in FIG. 2, the reflector 20 of the invention is also in the shape of a cylinder. The curved side surface of the cylinder has a slit opened longitudinally along the axis of the cylinder, and both ends are open. The reflector 20 is made of insulating material such as ceramics. Examples of the ceramics include oxides such as alumina, zirconia and magnesia; nitrides such as silicon nitride, boron nitride and aluminum nitride; and carbides such as silicon carbide. Alumina is particularly preferred. The thickness of the reflector is preferably in the range of 0.1 to 30 mm, more preferably in the range of 0.5 to 10 mm.

The combination of the heating crucible and reflector of the invention can comprise the heating crucible of FIG. 1 and the reflector of FIG. 2.

The reflector 20 is placed over the crucible 10, for example, in the manner as shown in FIG. 3. In FIG. 3, the reflector 20 and the cylindrical crucible 10 are placed so that the axis of the cylindrical reflector 20 is parallel to that of the cylindrical crucible 10 and so that the longitudinal aperture 11 of the crucible 10 projects out of the slit of the reflector 20. In that way, the crucible 10 is covered with the reflector 20. The crucible 10 is fixed while the electric terminals 12a and 12b are connected to electrodes 31 and 32, respectively. The reflector 20 is placed and fixed on a holder 33.

The gap between the reflector 20 and the crucible 10 generally is in the range of 0 to 500 mm. In order to insulate heat effectively, the reflector 20 preferably is not in contact with the crucible 10. The gap is, therefore, preferably in the range of 0.5 to 30 mm, more preferably in the range of 1 to 10 mm.

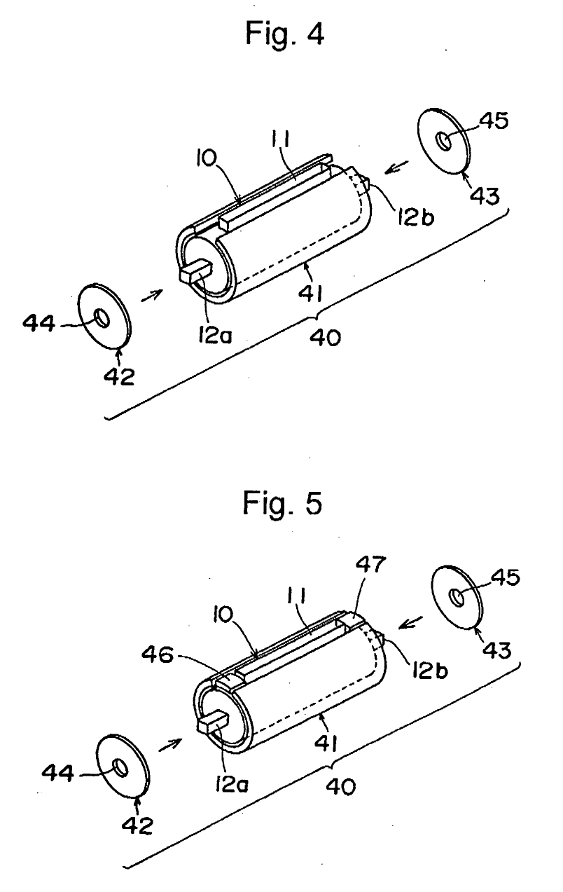

The reflector of the invention can have a structure shown in FIG. 4. FIG. 4 is a sketch schematically illustrating the heating crucible covered with another example of the reflector of the invention. In FIG. 4, the reflector 40 comprises two disc plates 42 and 43 as well as an open-ended cylinder 41 having a slit (which is the same as 20 in FIG. 2). At the centers of the disc plates 42 and 43, holes 44 and 43 placed over on the crucible 10 in the manner as described and shown in FIG. 3, the plates 42 and 43 are brought in the directions shown by the arrows in FIG. 4 so that the electric terminals 12a and 12b pierce through the holes 44 and 45, respectively. The whole crucible 10 is thus jacketed in the reflector 40, and thereby the energy efficiency can be further improved. Also in that case, the gap between the reflector 40 and the crucible 10 is preferably set to be in the aforementioned range.

The reflector of the invention can have a structure shown in FIG. 5, which has a piece of two auxiliary reflector units 46, 47. By the provision of the auxiliary reflector units 46, 47, the heating crucible is more appropriately covered with the reflector. It is preferred that the hearing crucible has less exposed area (which is not covered with the reflector), such as not more than 30%, more preferably not more than 10%.

In the invention, the heating crucible and the reflector are not restricted to the structures shown in FIGS. 1 to 5. The shape of the reflector can be suitably modified according to the shape of the heating crucible.

In the following description, the process of the invention for preparation of a radiation image storage panel is explained in detail referring to the attached drawings, by way of example, in the case where the phosphor is an energy-storing phosphor.

The substrate on which the deposited phosphor layer is to be formed is generally used as a support of the storage panel, and hence can be optionally selected from known materials used as the support of the conventional radiation image storage panel. The substrate preferably is a sheet of quartz glass, sapphire glass; metal such as aluminum, iron, tin or chromium; or resin such as aromatic polyimide. For improving the sensitivity or the image quality (e.g., sharpness and graininess), known auxiliary layers such as a light-reflecting layer (which contains a light-reflecting material such as titanium dioxide) and a light-absorbing layer (which contains a light-absorbing material such as carbon black) can be optionally provided according to the object and use of the storage panel. Further, in order to promote growth of the columnar crystals, a great number of very small convexes or concaves may be provided on the substrate surface (or on the auxiliary layer such as an undercoating (adherent) layer, a light-reflecting layer or a light-absorbing layer, if provided) on which the vapor is to be deposited.

The energy-storing phosphor preferably is a stimulable phosphor giving off stimulated emission in the wavelength region of 300 to 500 nm when exposed to stimulating rays in the wavelength region of 400 to 900 nm.

Particularly preferred is an alkali metal halide stimulable phosphor represented by the following formula (I):
M^{I}X·aM^{II}X′₂·bM^{III}X″₃:zA (I)
in which M^{I} is at least one alkali metal selected from the group consisting of Li, Na, K, Rb and Cs; M^{II} is at least one alkaline earth metal or divalent metal selected from the group consisting of Be, Mg, Ca, Sr, Ba, Ni, Cu, Zn and Cd; M^{III} is at least one rare earth element or trivalent metal selected from the group consisting of Sc, Y, La, Ce, Pr, Nd, Pm, Sm, Eu, Gd, Tb, Dy, Ho, Er, Th, Yb, Lu, Al, Ga and In; A is at least one rare earth element or metal selected from the group consisting of Y, Ce, Pr, Nd, Sm, Eu, Gd, Tb, Dy, Ho, Er, Tm, Yb, Lu, Mg, Cu and Bi; each of X, X′ and X′ is independently at least one halogen selected from the group consisting of F. Cl, Br and I; and a, b and z are numbers satisfying the conditions of 0≦a<0.5, 0≦b<0.5 and 0<z<1.0, respectively.

The number represented by z in the formula (I) preferably satisfies the condition of 1×10⁻⁴≦z≦0.1. The phosphor of the formula (I) preferably contains at least Cs as M^{I} and at least Br as X. In the formula (I), A is preferably Eu or Bi, more preferably Eu. Further, the phosphor of the formula (I) can contain metal oxides such as aluminum oxide, silicon dioxide and zirconium oxide, if needed, in an amount of 0.5 mol or less per 1 mol of M^{I}X.

It is also preferred to use a rare earth activated alkaline earth metal fluoride halide stimulable phosphor represented by the following formula (II):
M^{II}FX:zLn (II)
in which M^{II} is at least one alkaline earth metal selected from the group consisting of Ba, Sr and Ca; Ln is at least one rare earth element selected from the group consisting of Ce, Pr, Sm, Eu, Th, Dy, Ho, Nd, Er, Tm and Yb; X is at least one halogen selected from the group consisting of Cl, Br and I; and z is a number satisfying the condition of 0<z≦0.2.

Still more preferred is a rare earth activated alkaline earth metal sulfide stimulable phosphor represented by the following formula (III):
M^{II}S:A,Sm (II)
in which M^{II} is at least one alkaline earth metal selected from the group consisting of Mg, Ca and Sr; and A is preferably Eu and/or Ce.

Further, yet another preferred phosphor is a cerium activated trivalent metal oxide halide stimulable phosphor represented by the following formula (IV):
M^{III}OX:Ce (IV)
in which M^{III} is at least one rare earth element or trivalent metal selected from the group consisting of Pr, Nd, Pm, Sm, Eu, Tb, Dy, Ho, Er, Tm, Yb and Bi; and X is at least one halogen selected from the group consisting of Cl, Br and I.

The phosphor used in the invention is not restricted to the energy-storing phosphor. It may be a phosphor absorbing radiation such as X-rays and spontaneously giving off (instant) emission in the ultraviolet or visible resin. Examples of these phosphors include phosphors of LnTaO₄:(Nb, Gd) type, Ln₂SiO₅:Ce type and LnOX:Tm type (Ln is a rare earth element); CsX (X is a halogen) type; Gd₂O₂S:Tb; Gd₂O₂S:Pr,Ce; ZnWO₄; LuAlO₃:Ce; Gd₃Ga₅O₁₂:Cr,Ce; and HfO₂.

In the case where the vapor-deposited phosphor layer is formed by multi-vapor deposition (co-deposition), at least two evaporation sources are used. One of the sources contains a matrix material of the phosphor, and the other contains an activator material. The multi-vapor deposition is preferred because the vaporization rate of each source can be independently controlled to incorporate the activator uniformly in the matrix even if the materials have very different melting points or vapor pressures. According to the composition of the target phosphor, each evaporation source may consist of the matrix material or the activator material only or otherwise may be a mixture thereof with additives. Three or more sources can be used. For example, in addition to the above-mentioned sources, another evaporation source containing additives may be used.

The matrix material of the phosphor may be either the matrix compound itself or a mixture of two or more substances that react with each other to produce the matrix compound. The activator material generally is a compound containing an activating element, and hence is, for example, a halide or oxide of the activating element.

If the activator is Eu, the Eu-containing compound of the activator material preferably contains Eu²⁺ as much as possible because the aimed stimulated emission (even if, instant emission) is emitted from the phosphor activated by EU²⁺. Since contaminated with oxygen, commercially available Eu-containing compounds generally contain both Eu²⁺ and Eu³⁺. The Eu-containing compounds, therefore, are preferably melted under Br gas- containing atmosphere so that oxygen-free EuBr₂ can be prepared.

The evaporation source preferably contains less water such as in a content of 0.5 wt. % or less. For preventing the source from bumping, it is particularly important to keep the water content in the above low range it the material of matrix or activator is a hygroscopic substance such as EuBr or CsBr. The materials are preferably dried by heating to 100 to 300° C. under reduced pressure. Otherwise, the materials may be heated under dry atmosphere such as nitrogen gas atmosphere to melt at a temperature above the-melting point for several minutes to several hours.

The evaporation source, particularly the source of the matrix material, contains less impurities of alkali metal (alkali metals other than ones constituting the phosphor) preferably in a content of 10 ppm or less and less impurities of alkaline earth metal (alkaline earth metals other than ones constituting the phosphor) preferably in a content of 5 ppm or less (by weight). The less impurities and water are particularly preferred if the phosphor is an alkali metal halide stimulable phosphor represented by the formula (I). Such preferred evaporation source can be prepared from materials containing the impurities little.

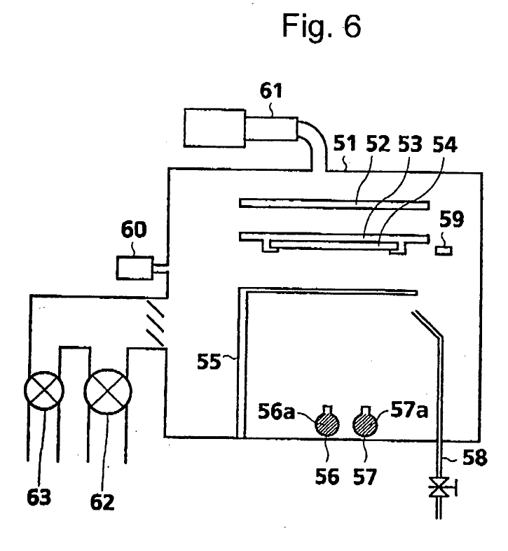

In the invention, a deposited phosphor layer can be formed on a substrate, for example, in the evaporation-deposition apparatus shown in FIG. 6. The apparatus is equipped with the resistance-heating crucibles.

FIG. 6 is a sectional view schematically illustrating an example of the evaporation-deposition apparatus used in the invention. The apparatus shown in FIG. 6 comprises a chamber 51, a substrate heater 52, a substrate holder 53, a shutter 55, resistance-heating crucibles 56 and 57, a gas-intake pipe 58, a deposition rate monitor 59, a vacuum gauge 60, a gas analyzer 61, a main exhaust valve 62, and an auxiliary exhaust valve 63. Each of the resistance-heating crucibles 56 and 57 has the structure shown in FIG. 1, and is covered with the reflector shown in FIG. 2 as shown in FIG. 3.

In the apparatus shown in FIG. 6, the two evaporation sources 56a, 57a are placed in the heating crucibles 56 and 57, respectively. The substrate 54 is mounted on the substrate holder 53. The distance between each evaporation source 56a or 57a and the substrate 54 is normally in the range of 10 to 1,000 mm, and the distance between the evaporation sources 56a and 57a is normally in the range of 10 to 1,000 mm. The chamber 51 is then evacuated through the main exhaust valve 62 and the auxiliary exhaust valve 63, to make the inner pressure in the range of 0.1 to 10 Pa, preferably 0.1 to 4 Pa (medium vacuum). Preferably after the chamber 51 is evacuated to make the inner pressure in the range of 1×10⁻⁵ to 1×10⁻² Pa (high vacuum), an inert gas such as Ar, Ne or N₂ gas is introduced through the intake pipe 58 so that the inner pressure may be in the range of 0.1 to 10 Pa, preferably 0.1 to 4 Pa. In this way, partial pressures of water and oxygen can be reduced. The degree of vacuum in the chamber 51 is monitored with the vacuum gauge 60, and the partial pressures of gases are monitored with the gas analyzer 61. The chamber 51 can be evacuated by means of an optional combination of, for example, a rotary pump, a turbo molecular pumps a cryo pump, a diffusion pump and a mechanical buster.

In the course of conducting the evaporation-deposition process, the substrate 54 may be heated from the back by means of the substrate heater 52, or may be cooled, if needed. The temperature of the substrate generally is in the range of 20 to 350° C., preferably in the range of 100 to 300° C. Further, the substrate 54 may be linearly moved forward and backward repeatedly, may be spun around, or may be revolved.

For heating the evaporation sources 56a, 57a, electric currents are then supplied to the heating crucibles 56 and 57. When the evaporation sources are heated enough to vaporize, the shutter 55 is opened. The vaporized substances are reacted with each other to form the phosphor, which is deposited and accumulated on the substrate 54. The deposition rate, which means how fast the formed phosphor is deposited and accumulated on the substrate, can be controlled by adjusting the electric currents supplied to the heating crucibles. The deposition rate of each vaporized phosphor component can be detected with the monitor 59 at any time during the deposition. The deposition rate generally is in the range of 0.1 to 1,000 μm/minute, preferably in the range of 1 to 100 μm/minute.

In the invention, since the crucible is covered with the reflector, for example, as shown in FIG. 3, heat radiated from the crucible is reflected, prevented from coming out, and kept therein. Consequently, uneven thermal distribution in the crucible is remarkably reduced or minimized to prevent bumping in the vapor-deposition process and thereby to form a phosphor layer consisting of the phosphor deposited in the form of preferred columnar crystals. Further, since the crucible is thus kept from radiating heat, the substrate is not unfavorably heated. In addition, thermal interference among plural crucibles is also avoided, and hence it is easy to control the amount of vapor evaporated from each crucible properly enough to form a homogeneous phosphor layer. Furthermore, since the crucible can be kept from scorching, it can be used for a long period of time. Naturally, the present invention also improves thermal efficiency of the evaporation-deposition apparatus.

The heating may be repeated twice or more to form two or more phosphor layers. After the deposition procedure is completed, the deposited layer may be subjected to heating treatment (annealing treatment), which is carried out generally at a temperature of 100 to 300° C. for 0.5 to 3 hours, preferably at a temperature of 150 to 250° C. for 0.5 to 2 hours, under inert gas atmosphere which may contain a small amount of oxygen gas or hydrogen gas.

Before preparing the deposited phosphor layer, another layer consisting of the phosphor matrix alone may be beforehand formed. The layer of the phosphor matrix alone generally comprises agglomerate of columnar or spherical crystals, and the phosphor layer formed thereon is well crystallized in the form of columnar shape. In the thus-formed layers, the additives such as the activator contained in the phosphor-deposited layer are often diffused into the matrix alone-deposited layer while they are heated during the deposition and/or during the heating treatment performed after the deposition, and consequently the interface between the layers is not always clear.

The evaporation-deposition apparatus employable in the invention is not restricted to FIG. 6. For example, plural pairs of the evaporation sources may be arranged. Further, only one evaporation source or three or more evaporation sources may be used. In the case where the phosphor layer is produced by mono-vapor deposition, only one evaporation source containing the phosphor or a mixture of materials thereof is heated in a single resistance-heating crucible. The evaporation source is beforehand prepared so that it may contain the activator in a desired amount. Otherwise, in consideration of the difference of vapor pressure between the matrix components and the activator, the deposition procedure may be carried out while the matrix components are being supplied to the evaporation source.

Thus produced phosphor layer consists of a phosphor in the form of columnar crystals grown almost in the thickness direction. The phosphor layer contains no binder and consists of the phosphor only, and there are gaps among the columnar crystals. The thickness of the phosphor layer depends on, for example, aimed characteristics of the panel, conditions and process of the deposition, but is normally in the range of 50 μm to 1 mm, preferably in the range of 200 to 700 μm.

It is not always necessary for the substrate to be used as a support of the radiation image storage panel. For example, after formed on the substrate, the deposited phosphor film (layer) can be peeled from the substrate and then laminated on a support with an adhesive to fix the phosphor layer. Otherwise, the support (substrate) may be omitted.

It is preferred to provide a protective layer on the surface of the phosphor layer, so as to ensure good handling of the storage panel in transportation and to avoid deterioration, The protective layer is preferably transparent so as not to prevent the stimulating light from coming in or not to prevent storage panel from chemical deterioration and physical damage, the protective layer preferably is chemically stable, physically strong, and of high moisture proof.

The protective layer can be provided by coating the phosphor layer with a solution in which an organic polymer such as cellulose derivatives, polymethyl methacrylate or fluororesins soluble in organic solvents is dissolved in a solvent, by placing a beforehand prepared sheet for the protective layer (e.g., a film of organic polymer such as polyethylene terephthalate, a transparent glass plate) on the phosphor layer with an adhesive, or by depositing vapor of inorganic compounds on the phosphor layer. Various additives may be dispersed in the protective layer. Examples of the additives include light-scattering fine particles (e.g., particles of magnesium oxide, zinc oxide, titanium dioxide and alumina), slipping agent (e.g., powders of perfluoroolefin resin and silicone resin) and a crosslinking agent (e.g., polyisocyanate). The thickness of the protective layer is generally in the range of about 0.1 to 20 μm if the layer is made of polymer material or in the range of about 100 to 1,000 μm if the layer is made of inorganic material such as glass.

Thus, a radiation image storage panel can be produced according to the invention. The storage panel may be in known various structures. For example, in order to improve the sharpness of the resultant image, at least one of the layers may be colored with a colorant which does not absorb the stimulated emission but the stimulating ray.

### EXAMPLE 1

(1) Evaporation Source

A powdery cesium bromide (CsBr, purity: 4N or more) and a powdery europium bromide (EuOr₂, purity: 3N or more) were prepared. The powdery europium bromide was placed in a platinum crucible, heated to melt at 800° C. in a tube furnace under a halogen gas atmosphere for preventing oxidization, and cooled, Thus melted and cooled EuBr₂ and the powdery CsBr were used as the evaporation sources. Each evaporation source was analyzed according to ICP-MS method (Inductively Coupled Plasma Mass Spectrometry), to find impurities. As a result, the CsBr powder contained each of the alkali metals (Li, Na, K, Rb) other than Cs in an amount of 10 ppm or less and other elements such as alkaline earth metals (Mg, Ca, Sr, Ba) in amounts of 2 ppm or less. The melted and cooled EuBr₂ contained each of the rare earth elements other than Eu in an amount of 20 ppm or less and other elements in amounts of 10 ppm or less. Those evaporation sources are very hygroscopic, and hence were stored in a desiccator keeping a dry condition whose dew point was −20° C. or below. Immediately before used, they were taken out of the desiccator.

(2) Preparation of Phosphor Layer

A glass substrate (available from Corning) as a support was mounted on a substrate holder 53 in an evaporation-deposition apparatus shown in FIG. 6. The CsBr and EuBr₂ evaporation sources 56a and 57a were individually placed in the heating crucibles 56 and 57, respectively. The heating crucibles 56 and 57 were covered with alumina-made reflectors (thickness: 5 mm) as shown in FIG. 3 (approx. 25% of the outer surface of the crucible was exposed), so that the gap between each crucible and the reflector was in the range of approx. 2 to 7 mm. The distance between each evaporation source 56a or 57a and the substrate 54 was 150 mm. The chamber 51 was then evacuated to make the inner pressure 1×10⁻³ Pa through the rain exhaust valve 62 by means a combination of a rotary pump, a mechanical booster and a diffusion pump. Further, for removing moisture, a moisture-evacuating cryo pump was used. After the main exhaust valve 62 was closed and the auxiliary exhaust valve 63 was opened, Ar gas was introduced through the intake pipe 58 to set the inner pressure at 0.8 Pa. In the thus-prepared atmosphere, Ar plasma was generated by means of a plasma-generator (ion gun, not shown) to wash the surface of the substrate. The auxiliary exhaust valve 63 was closed and the main exhaust valve 62 was opened, and then the chamber 51 was again evacuated to mike the inner pressure 1×10⁻³ Pa. Successively, Ar gas was introduced again to set the inner pressure (Ar gas pressure) at 1.0 Pa. While the shutter 55 was kept closed, electric currents were supplied to the heating crucibles 56 and 57 so as to heat the evaporation sources 56a and 57a, respectively. The shutter 55 was then partly opened so that only the CsBr vapor evaporated from the CsBr source 56a was deposited and accumulated on the substrate 54, to form a base layer of CsBr (phosphor matrix). Three minutes after that, the shutter 55 was fully opened so that CsBr:Eu stimulable phosphor was deposited and accumulated on the base layer. The deposition rate was 20 μm/minute. During the deposition, the electric currents supplied to the heating crucibles 56, 57 were controlled so that the molar ratio of Eu/Cs in the deposited phosphor might be 0.003/1. After the evaporation-deposition was complete, the inner pressure of the chamber 51 was returned to atmospheric pressure and then the substrate 54 was taken out of the apparatus. On the substrate, a phosphor layer (thickness: 700 μm, area: 10 cm×10 cm) was formed. The formed phosphor layer consisted of the phosphor in the form of columnar crystals grown almost perpendicularly and aligned densely.

In the course of the heating the crucible, the heat distribution in the crucible was examined using thermocouples. It was confirmed that the temperatures in any places of the crucible were within ±4° C. of an average temperature.

Thus, a radiation image storage panel comprising the support and the stimulable phosphor layer was produced according to the invention.

### EXAMPLE 2

The procedures of Example 1-(2) were repeated using the combination of the direct resistance-heating crucible and the reflector (as illustrated in FIG. 4, approx. 8% of the outer surface of the crucible was exposed), to prepare a radiation image storage panel of the invention comprising a support and a stimulable phosphor layer.

In the course of the heating the crucible, the heat distribution in the crucible was examined using thermocouples. It was confirmed that the temperatures in any places of the crucible were within ±1° C. of an average temperature.

### EXAMPLE 3

The procedures of Example 1-(2) were repeated using the combination of the direct resistance-heating crucible and the reflector (as illustrated in FIG. 5, approx. 7% of the outer surface of the crucible was exposed), to prepare a radiation image storage panel of the invention comprising a support and a stimulable phosphor layer.

In the course of the heating the crucible, the heat distribution in the crucible was examined using thermocouples. It was confirmed that the temperatures in any places of the crucible were within ±1° C. of an average temperature.

### Comparison Example 1

The procedure of Example 1 was repeated except that the heating crucibles 56 and 57 were not covered with-the alumina-made reflectors in the above step (2), that is, 100% of the outer surface of the crucible was exposed), to produce a radiation image storage panel for comparison.

In the course of the heating the crucible, the heat distribution in the crucible was examined using thermocouples. It was confirmed that the temperatures in any places of the crucible were within ±15° C. of an average temperature.

### Evaluation of Radiation Image Storage Panel

Each produced storage panel was evaluated on the basis of point defects observed in the reproduced radiation image.

Each produced storage panel was exposed to X-rays emitted from a tungsten tube (voltage: 80 kVp) in the amount of 10 mR (2.58×10⁻⁶ C/kg). A semiconductor laser beam (wavelength: 660 nm) was then applied onto the panel so that the stimulating energy on the panel surface might be 5 J/cm², and stimulated emission given off from the panel was detected by a photomultiplier (S-5). The detected emission was converted into electric signals, from which a radiation image was reproduced by means of an image-reproducing apparatus. The reproduced image was observed with the unaided eyes, and thereby point defects (dark or bright points spotted in the image) were counted in an area of 100 mm×100 mm.

The results are set forth in Table 1.

TABLE 1

| | Reflector | Exposed | Temperature | Point |
|---|---|---|---|---|
| Example | (Figure) | area | distribution | defects |
| Example 1 | | 25% | ±4° C. | 15 |
| Example 2 | | 8% | ±1° C. | 10 |
| Example 3 | | 7% | ±1° C. | 6 |
| Com. Ex. 1 | None | 100% | ±15° C. | 80 |

The results shown in Table 1 clearly indicate that the radiation image storage panel of Examples 1 to 3 (whose phosphor layer was formed by the vapor-deposition process in which the heating crucibles were covered with the reflectors of the invention) gave a reproduced radiation image having a reduced number of point defects, as compared with the radiation image storage panel of Comparison example 1 (whose phosphor layer was formed by the vapor-deposition process in which the heating crucibles were not covered with the reflectors).

### EXAMPLE 4

The procedure of Example 1 was repeated except that, in the above step (2), only the CsBr evaporation source was placed in the heating crucible 56 and vaporized to form a CsBr deposited layer on the substrate. In that vapor-deposition process, the energy of 1,589 W was consumed to elevate the temperature inside the crucible at 700° C. Also in the process, the temperature inside the crucible was measured at two positions by means of a thermocouple. It was found that the temperature measured at one position was almost identical with the temperatures measured at the other positions.

### Comparison Example 2

The procedure of Example 1 was repeated except that, in the above step (2), only the CsBr evaporation source was placed in the heating crucible 56 not covered with the reflector and vaporized to form a CsBr deposited layer on the substrate. In that vapor-deposition process, the energy of 1,683 W was consumed to elevate the temperature inside the crucible at 700° C. Also in the process, the temperature inside the crucible was measured at two positions by means of a thermocouples. It was found that the temperature measured at one position was different from that measured at the other position.

What is claimed is:

1. An insulating reflector having a shape surrounding and covering a heating crucible which generates heat when electricity is supplied.

2. The reflector of claim 1, wherein the reflector is made of ceramics.

3. A combination of a heating crucible which generates heat when electricity is supplied and an insulating reflector having a shape surrounding and covering the crucible.

4. The combination of claim 3, wherein the reflector is made of ceramics.

5. The combination of claim 3, wherein the reflector comprises a cylindrical side-covering unit having a longitudinal aperture along a center axis of the covering unit and a pair of end-covering disc plates.

6. The combination of claim 3, wherein the heating crucible is in the form of a cylindrical container having a curved side surface on which a longitudinal aperture is formed along a center axis of the container and end surfaces to which an electric terminal is fixed, and at least 70% of an outer surface of the crucible is enclosed with the reflector.

7. The combination of claim 3, wherein at least 90% of the outer surface of the crucible is enclosed with the reflector.

8. The combination of claim 3, wherein the heating crucible is made of a metal selected from the group consisting of tantalum, molybdenum, tungsten and niobium.

9. A process for preparing a radiation image storage panel having a substrate and a phosphor layer, which comprises the step of placing an evaporation source of the phosphor in the crucible of the combination of claim 3, and heating the crucible under vacuum to vaporize the evaporation source and depositing the vaporized source on the substrate whereby forming the phosphor layer.
